(19) United States
(12) Patent Application Publication
(10) Pub. No.: US 2016/0034562 A1
(43) Pub. Date: Feb. 4, 2016

(54) METHOD AND SYSTEM FOR ORGANIZING MESSAGES AND REPORTING STATISTICS FOR MESSAGES IN A SOCIAL NETWORK

(71) Applicant: ANTHONY MALCOLM-DACOSTA, AJAX (CA)

(72) Inventor: ANTHONY MALCOLM-DACOSTA, AJAX (CA)

(21) Appl. No.: 14/493,943

(22) Filed: Sep. 23, 2014

Related U.S. Application Data
(60) Provisional application No. 62/030,809, filed on Jul. 30, 2014.

(51) Int. Cl. G06F 17/30; G06F 3/0484; G06F 3/0482; H04L 12/58

(52) U.S. Cl. CPC G06F 17/30601; H04L 51/32; H04L 51/12; G06F 3/04842; G06F 3/0482; H04L 51/10

(57) ABSTRACT

A method for organizing messages and reporting statistics for messages in a social network, the social network communicatively coupling a user's data processing system to one or more supporters' respective data processing systems over a communications network, the method comprising: using a processor, selecting a category for a message from among a predetermined group of categories; posting the message to the social network under the category, the message including an identifier of the category under which the message was posted; after the message is posted, determining a total number of messages posted under the category by the user and a total number of messages posted by the user; determining a percentage of the total number of messages posted under the category by the user to the total number of messages posted by the user; and, presenting the percentage on a display.

This application claims priority from and the benefit of the filing date of U.S. Provisional Patent Application No. 62/030,809, filed Jul. 30, 2014, and the entire content of such application is incorporated herein by reference.

### FIELD OF THE INVENTION

This invention relates to the field of data processing and social networks, and more specifically, to a method and system for organizing messages and reporting statistics for messages in a social network.

### BACKGROUND OF THE INVENTION

The popularity of social networks has increased greatly in recent years. As a result, the amount of content that is generated by users and submitted to social networks has also increased. This content is then received and consumed by other users of the social network. One popular method of consuming social network content involves the implementation of content “feeds.” A content feed is used to deliver a stream of content to users subscribed to the feed. For example, a user may subscribe to a feed associated with his or her friend. As another example, a feed may correspond to a certain category of friends and deliver all content generated by those friends. As another example, a feed may correspond to a specific type of content (e.g., emails, text messages, posts, etc.).

However, one problem with existing social networks is the large volume of unfiltered content that a user may receive. For example, the user may not be interested in all of the content that the user receives or the user may not be interested in all of the types of content that the user receives even when implementing feeds. As a result, much of the content a user receives from the social network may be perceived as “noise” to the user.

A need therefore exists for an improved method and system for organizing messages and reporting statistics for messages in a social network. Accordingly, a solution that addresses, at least in part, the above and other shortcomings is desired.

### SUMMARY OF THE INVENTION

According to one aspect of the invention, there is provided a method for organizing messages and reporting statistics for messages in a social network, the social network communicatively coupling a user's data processing system to one or more supporters' respective data processing systems over a communications network, the method comprising: using a processor, selecting a category for a message from among a predetermined group of categories; posting the message to the social network under the category, the message including an identifier of the category under which the message was posted; after the message is posted, determining a total number of messages posted under the category by the user and a total number of messages posted by the user; determining a percentage of the total number of messages posted under the category by the user to the total number of messages posted by the user; and, presenting the percentage on a display.

In accordance with further aspects of the invention, there is provided an apparatus such as a data processing system, a method for adapting same, as well as articles of manufacture such as a computer readable medium or product and computer program product or software product (e.g., comprising a non-transitory medium) having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a screen capture illustrating a home screen of a social network application in accordance with an embodiment of the invention;

FIG. 3 is a screen capture illustrating the post input dialog box of FIG. 2 in accordance with an embodiment of the invention;

FIG. 4 is a screen capture illustrating the calculator window or box of FIG. 2 in accordance with an embodiment of the invention;

FIGS. 5A, 5B, and 5C is a flow chart illustrating operations of modules within a data processing system for calculating the percentage of posts of a selected post category with respect to the total number of posts for all categories, in accordance with an embodiment of the invention;

FIG. 6 is a block diagram illustrating a user calculator mode of a category calculator module in accordance with an embodiment of the invention;

FIG. 7 is a block diagram illustrating an individual calculator mode of a category calculator module in accordance with an embodiment of the invention;

FIG. 8 is a block diagram illustrating an owner's calculator mode of a category calculator module in accordance with an embodiment of the invention; and,

FIG. 9 is a flow chart illustrating operations of modules within a data processing system for organizing messages and reporting statistics for messages in a social network, in accordance with an embodiment of the invention.

It will be noted that throughout the appended drawings, like features are identified by like reference numerals.

### DETAILED DESCRIPTION OF THE EXEMPLARY EMBODIMENTS

In the following description, details are set forth to provide an understanding of the invention. In some instances, certain software, circuits, structures and methods have not been described or shown in detail in order not to obscure the invention. The term “data processing system” or “system” is used herein to refer to any machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

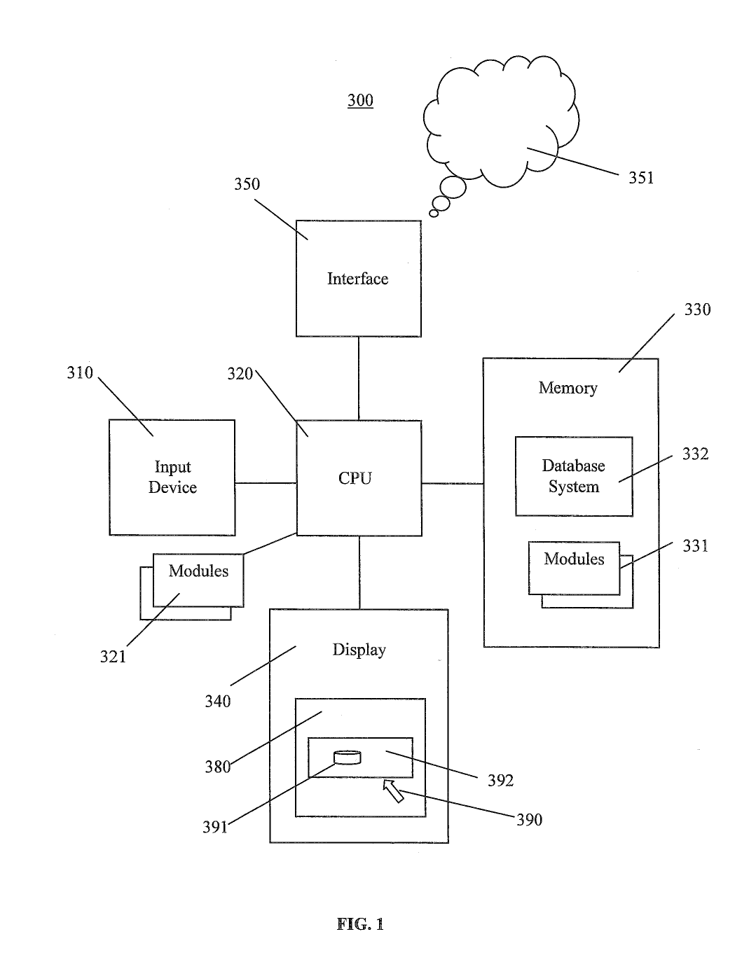

FIG. 1 is a block diagram illustrating a data processing system 300 in accordance with an embodiment of the invention. The data processing system 300 is suitable for data processing, management, storage, and for generating, displaying, and adjusting presentations in conjunction with a user interface or a graphical user interface (“GUI”), as described below. The data processing system 300 may be a client and/or server in a client/server system (e.g., 100). For example, the data processing system 300 may be a server system or a personal computer (“PC”) system. The data processing system 300 may also be a mobile device or other wireless, portable, or handheld device. The data processing system 300 may also be a distributed system which is deployed across multiple processors. The data processing system 300 may also be a virtual machine. The data processing system 300 includes an input device 310, at least one central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to the data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a data store or database system 332 for storing data and programming information. The database system 332 may include a database management system (e.g., 332) and a database (e.g., 332) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., one or more digital video disks (“DVDs”), compact disks (“CDs”), memory sticks, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium or product may be downloaded through an interface (e.g., 350) to the data processing system 300 from the network 351 by end users or potential buyers.

A user may interact with the data processing system 300 and its hardware and software modules 321, 331 using a user interface such as a graphical user interface (“GUI”) 380 (and related modules 321, 331). The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by selecting or “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

According to one embodiment of the invention, there is provided a social network in which a user may categorize both the user's and the user's supporters' (or friends') posts in categories in a user friendly manner. The user is able to keep track and be made aware of common/popular posts through information displayed in a calculator presented on the user's home screen. One advantage of the present invention is that it alleviates the common social network problem of having too many posts on a user's timeline for the user to review in a timely manner. The calculator reduces the noise associated with a high volume of posts by using categories that filter posted information in a user friendly and efficient manner. The categorization of posts allows users to conveniently and efficiently sort through their timelines. In addition to displaying information in categories, the calculator also displays percentages of posts sent or received on a category by category basis that helps users identify the popularity of categories with ease. The use of categorized posts provides the user with an improved experience over existing social networks.

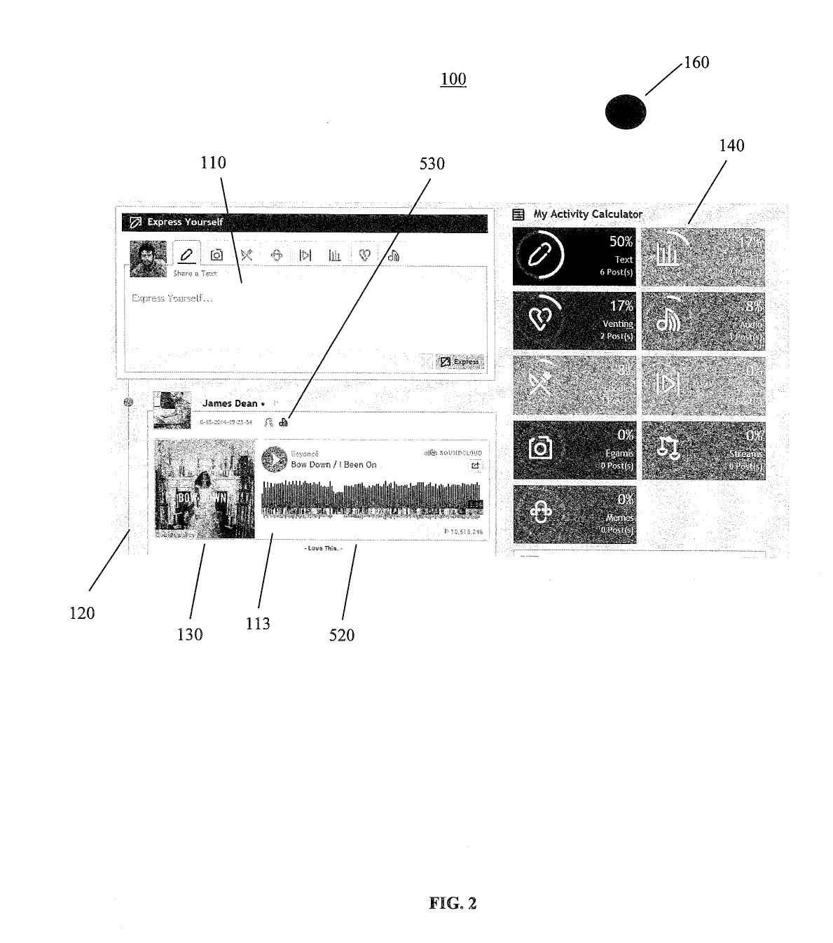

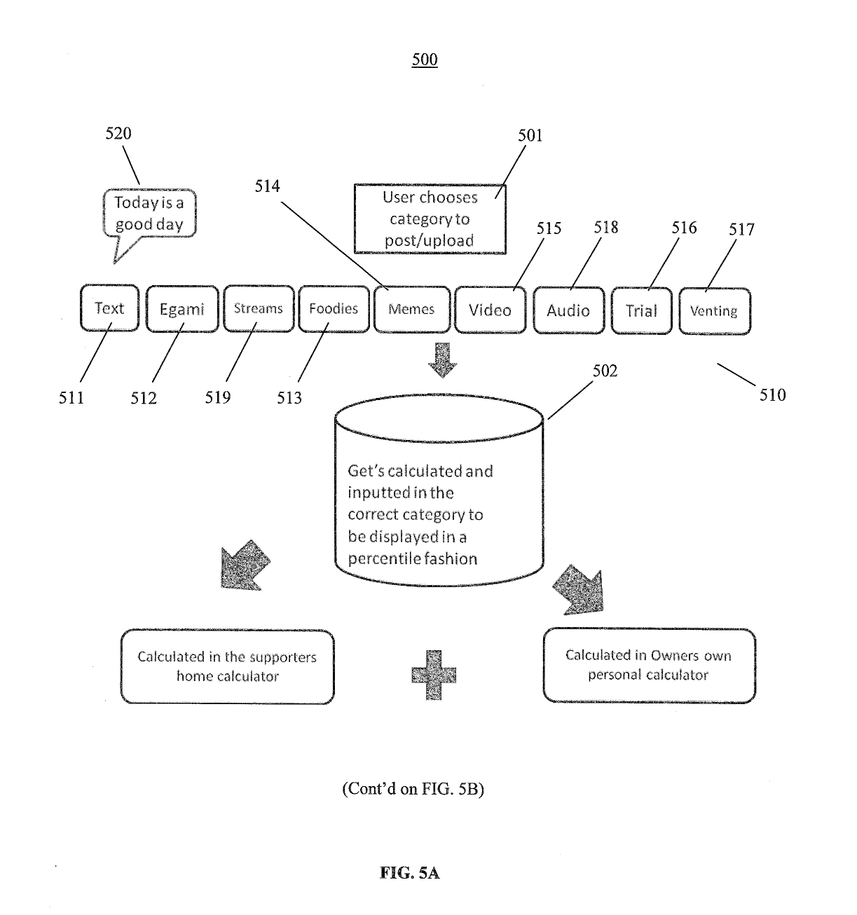

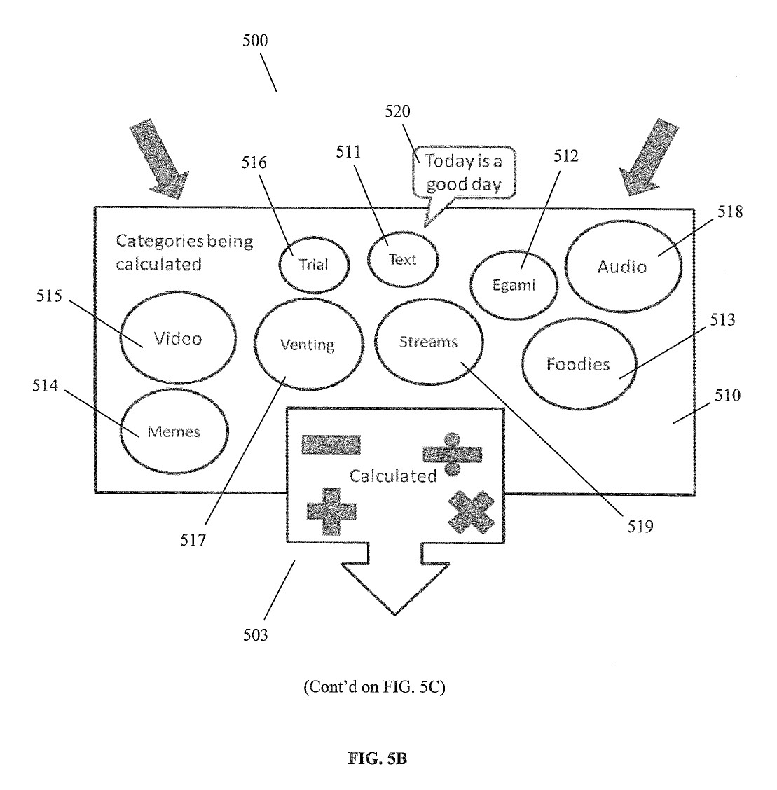

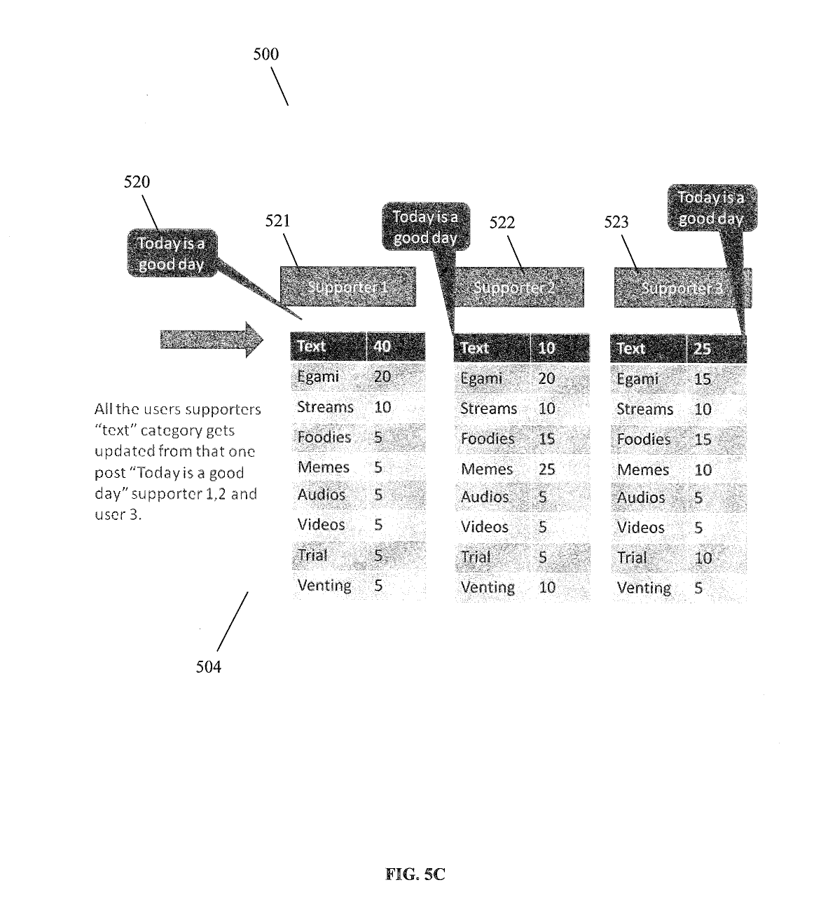

FIG. 2 is a screen capture illustrating a home screen 100 of a social network application or module(s) 331 in accordance with an embodiment of the invention. The home screen 100 includes a post input dialog window or box 110 for use by a user for inputting and categorizing post or message content 113, a timeline window or box 120 for listing or presenting posts or messages 520 or icons or windows 130 representing posts or messages 520 posted or sent by the user or received from other users (e.g., “James Dean”) of the social network application 331, and a calculator window or box 140 for indicating the percentage of posts or messages falling into specified categories of post or message types. The social network or social network application 331 may be implemented by modules 321, 331 running within the data processing system 300. The social network application 331 may run on respective data processing systems 300 associated with each user (e.g., 300) or supporter or friend (e.g., 521, 522, 523 in FIG. 5), the data processing systems 300, 521, 522, 523 being communicatively coupled over a network 351. The user's and supporters' data processing systems 300, 521, 522, 523 may be similar in configuration and operation to the data processing system 300.

For reference, a timeline (e.g., 120) is a way of displaying a list of events in chronological order. According to one embodiment, the timeline may be a graphic including a bar labelled with times/dates alongside one side and including event icons (e.g., 130) representing events labelled on the other side adjacent to the times/dates when the events occurred. The events may include the sending or receiving of posts, messages, text messages, emails, etc. According to another embodiment, the timeline may be a time/date ordered list of information or events such as the sending or receiving of posts, messages, text messages, emails, “likes”, etc. A user may review the content 113 of a post or message 520 listed on a timeline 120 by selecting the associated icon 130 for the event or entry corresponding to post or message 520.

Referring again to FIG. 2, according to one embodiment, a supporter indicator icon 160 is provided on the home screen 100. According to one embodiment, the supporter indicator icon 160 changes colour based on predetermined supporter number thresholds. For example, when the user has accumulated 100 supporters (or friends), the icon 160 may be presented in black. Similarly, when the user has accumulated 200 supporters, the icon 160 may be presented in purple. Similarly, when the user has accumulated 300 supporters, the icon 160 may be presented in pink. As a final example, when the user has accumulated 1,000,000 supporters, the icon 160 may be presented in orange. According to another embodiment, the supporter indicator icon 160 may change size, shape, and/or colour based on predetermined supporter number thresholds.

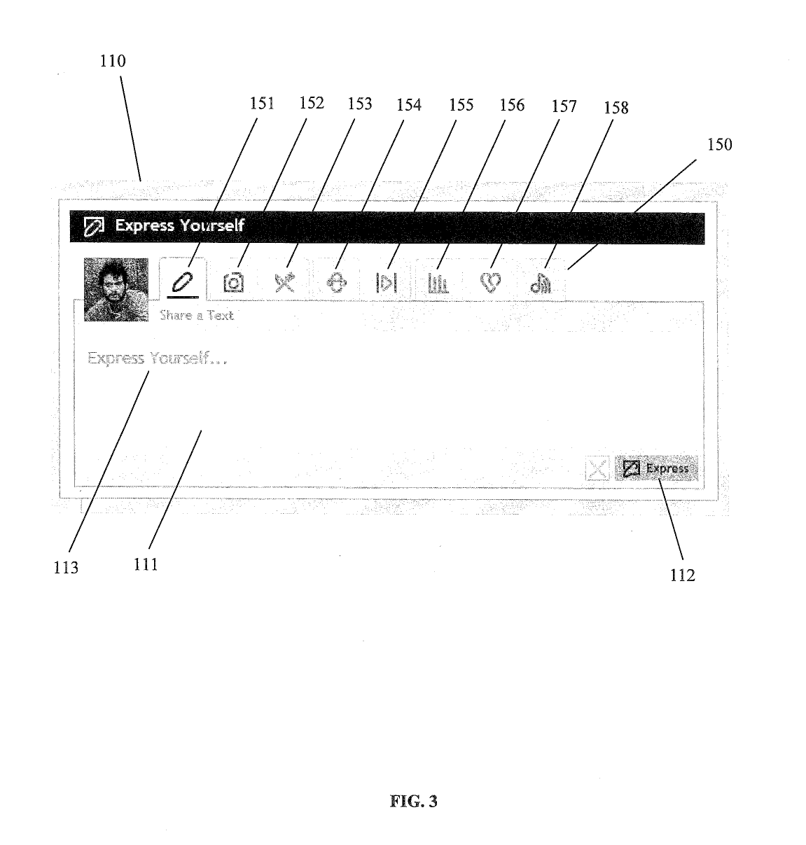

FIG. 3 is a screen capture illustrating the post input dialog box 110 of FIG. 2 in accordance with an embodiment of the invention. The post input dialog box 110 includes an input field 111 for a user to input or compose a post or message. A category bar 150 including a number of selectable category tabs 151, 152, 153, 154, 155, 156, 157, 158 is provided to allow a user to categorize the content 113 of the post or message 520 that the user has composed by selecting a category tab (e.g., 151) for a corresponding category. A post button 112 may be selected by the user to post or send a completed post or message 520 to other users of the social network application 331 over the network 351. The post or message 520 sent from the user includes a category identifier 530 for identifying the category selected for the post or message 520 by the user. According to one embodiment, the post or message 520 may be any form of electronic message including a text message, an email, a post, a “like” message or indication, a “tweet”, an instant message (“IM”), etc.

According to one embodiment, posts or messages 520 composed by the user may be categorized into one of the following categories, each having a corresponding tab 151, 152, 153, 154, 155, 156, 157, 158 in the category bar 150 of the post input dialog box 110:

“Text”: This category is used for text only posts (e.g., associated with category tab 151).

“Image” (or “Egami”): This category is used for image or picture only posts (e.g., associated with category tab 152).

“Streams”: This category is associated with the Image category. One property of this category is that a first user must give permission when posting a first image that it is acceptable for a second user to post a second image against the first image. In this case, other users of the social network application 331 may place a vote indicating their preferred image (i.e., the first image or the second image). This category may be associated with a category tab (not shown).

“Foodies”: This category is used for posting images of a user's food, for example, taken at a restaurant the user is visiting (e.g., associated with category tab 153).

“Memes”: This category is used for posting humorous images or characters with or without text relating to the image (e.g., associated with category tab 154).

“Videos”: This category is used for posting videos, YouTube™ video selections or links, Vimeo™ video selections or links, etc. (e.g., associated with category tab 155).

“Trials”: This category is associated with the Text category. One property of this category is that a first user must give permission when posting a first text message that it is acceptable for a second user to post a second text message against the first text message. In this case, other users of the social network application 331 may place a vote indicating their preferred text message (i.e., the first text message or the second text message). For example, the trial may post verbally or inherently the question, “What is your favourite restaurant?”, relating to a first text message stating “McDonalds™” and a second text message stating “Burger King™”. This category may be associated with category tab 156, for example.

“Venting”: This category is used for posting anonymous messages (e.g., without the user's username being attached to the message) to provide the user with a means of venting or expressing their emotions or feelings at a particular time or with respect a particular matter or event. This category may be associated with category tab 157, for example.

“Audio”: This category is used for posting audio files, YouTube™ audio selections or links, Vimeo™ audio selections or links, etc. (e.g., associated with category tab 158).

In FIG. 3, the user has entered the post or message content “Express Yourself” 113 as text in the input field 111 and has categorized the post or message 520 under the “Text” category (e.g., 511 in FIG. 5B) by selecting the “Text” category tab 151 from the category bar 150. When the post or message 520 is posted or sent, it will include a category identifier 530 for indicating the selected category (e.g., Text 511) for the content 113 of the post or message 520.

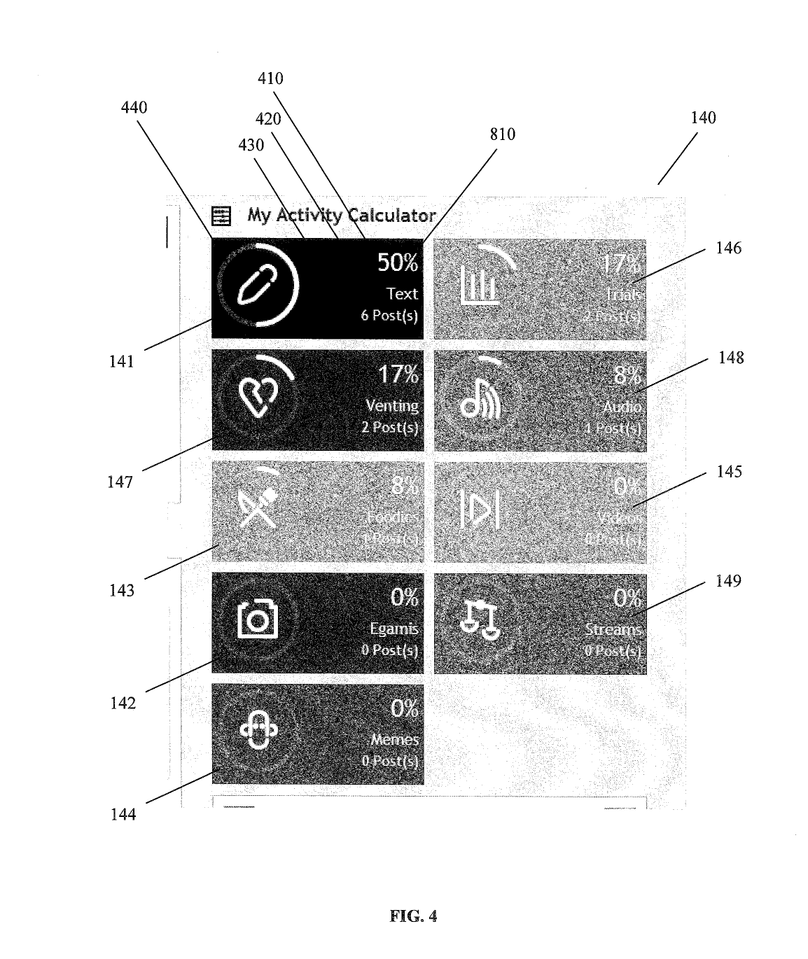

FIG. 4 is a screen capture illustrating the calculator window or box 140 of FIG. 2 in accordance with an embodiment of the invention. The calculator box 140 of the home screen 100 includes a category calculator window or box 141, 142, 143, 144, 145, 146, 147, 148, 149 for each respective post or message category. In particular, the calculator box 140 may include a “Text” category calculator box 141, an “Image” category calculator box 142, a “Streams” category calculator box 149, a “Foodies” category calculator box 143, a “Memes” category calculator box 144, a “Videos” category calculator box 145, a “Trials” category calculator box 146, a “Venting” category calculator box 147, and an “Audio” category calculator box 148. Each category calculator box 141, 142, 143, 144, 145, 146, 147, 148, 149 presents the results of calculations performed by a category calculator module 331 (or a respective category calculator module 331) of the social network application 331. The results of calculations performed by the category calculator module 331 (or by each category calculator module 331) is displayed in one or more fields 410, 420, 430, 440 in each category calculator box (e.g., 141). In the example shown in FIG. 4, a user has made 12 posts using the social network application 331. Of these 12 posts, 6 posts were “Text” category posts, 2 posts were “Venting” category posts, 1 post was a “Foodies” category post, 2 posts were “Trials” category posts, and 1 post was an “Audio” category post. As such, the category calculator module 331 associated with the “Text” category 511 would calculate that 6/12 or 50% of the total posts made by the user were “Text” category posts and would present this result 810 in a percent field 410 of the “Text” category calculator box 141. The category calculator module 331 may also present the following in the “Text” category calculator box 141: the total number of “Text” category posts (e.g., 6) in a number of posts field 430, the name of the category (e.g., “Text”) in a category name field 420, and an “Text” category icon 440 representing the “Text” category 511. Note that this icon 440 may be the same as that presented on the corresponding category tab 151 on the category bar 150 for the category 511.

FIGS. 5A, 5B, and 5C is a flow chart illustrating operations 500 of modules (e.g., 331) within a data process system (e.g., 300) for calculating the percentage of posts of a selected post category (e.g., 511) with respect to the total number of posts for all categories 510, in accordance with an embodiment of the invention.

At step 501, the operations 500 start with the user choosing a category (e.g., “Text” 511) for the user's post, upload, or message 520. As described above, the categories 510 may include a “Text” category 511, an “Image” category 512, a “Streams” category 519, a “Foodies” category 513, a “Memes” category 514, a “Videos” category 515, a “Trials” category 516, a “Venting” category 517, and an “Audio” category 518. For example, the user may choose the “Text” category 511 for the user's text message “Today is a good day” 520.

At step 502, the text message 520 is categorized into or associated with the selected category (e.g., “Text” 511).

At step 503, the percentage of posts of the selected post category (e.g., “Text” 511) with respect to the total number of posts for all categories 510 is calculated. This calculation is performed for each user or supporter (e.g., 521, 522, 523) using the social network application 331.

At step 504, the result of the calculation (e.g., 40%, 10%, and 25%) for each user or supporter is presented in the appropriate category calculator box (e.g., 141) for each user or supporter. The percentages shown in the remaining category calculator boxes (e.g., 142, 143, 144, 145, 146, 147, 148, 149) are also updated and the operations 500 end.

According to one embodiment, the category calculator module 331 has three modes of operation: a user calculator mode, an individual calculator mode, and an owners calculator mode. As such, the category calculator module 331 operates as a “3-in-1” calculator. A user may select between each of these three modes of operation.

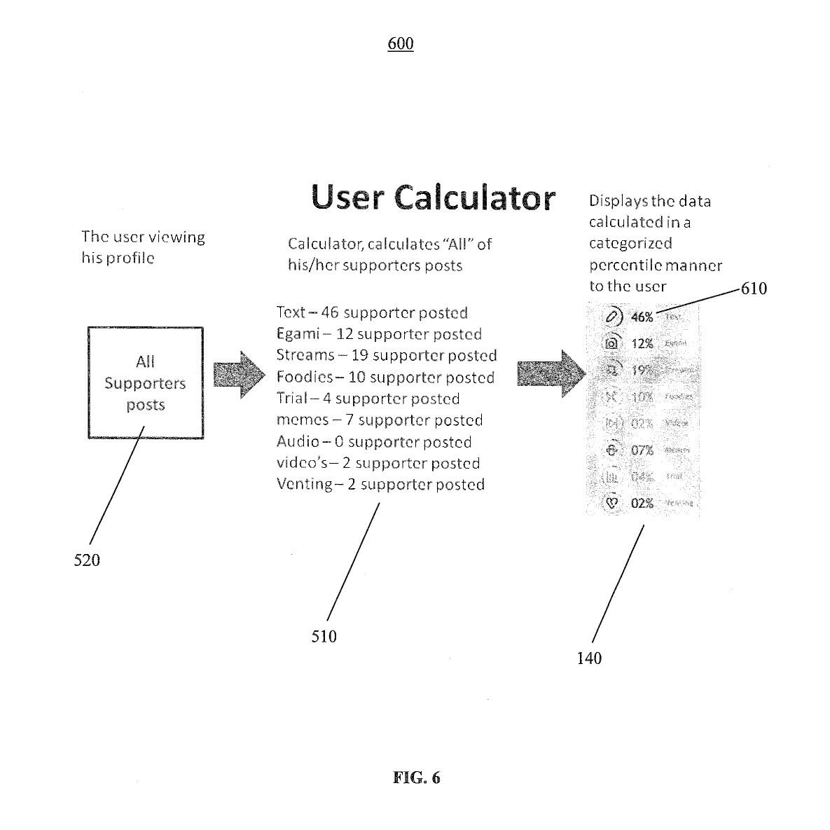

FIG. 6 is a block diagram illustrating a user calculator mode 600 of a category calculator module 331 in accordance with an embodiment of the invention. In the user calculator mode 600, the category calculator module 331 calculates data for all of a user's supporters' posts and shows the user the data collected and the statistics (e.g., percentages) calculated in a percentile manner in the calculator box 140 of the user's home screen 100. The user calculator mode 600 display is typically presented on a user's home screen 100 to allow the user, when logging on, to see what the user's supporters or friends are doing in a categorized percentile manner. For example, in FIG. 6, a user's supporters or friends 521, 522, 523 have made 100 post of which 46 are “Text” category 511 posts, 12 are “Image” category 512 posts, 19 are “Streams” category 519 posts, 10 are “Foodies” category 513 posts, 4 are “Trial” category 516 posts, 7 are “Memes” category 514 posts, 0 are “Audio” category 518 posts, 2 are “Video” category 515 posts, and 2 are “Venting” category 517 posts. As such, in the user calculator mode 600, the category calculator module 331 will calculate that 46% of the posts are in the “Text” category 511, 12% of the posts are in the “Image” category 512, 19% of the posts are in the “Streams” category 519, 10% of the posts are in the “Foodies” category 513, 7% of the posts are in the “Memes” category 514, 0% of the posts are in the “Audio” category 518, 2% of the posts are in the “Videos” category 515, and 2% of the posts are in the “Trials” category 516. These resulting data and statistics 610 are then displayed in one or more fields 410, 420, 430, 440 in each category calculator box (e.g., 141) of the calculator box 140 on the user's home screen 100.

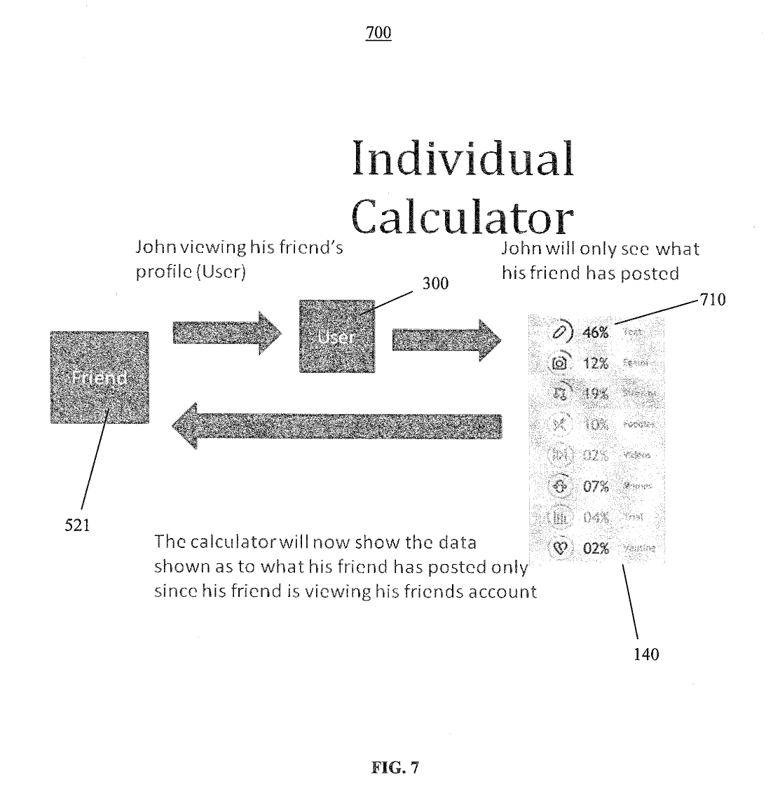

FIG. 7 is a block diagram illustrating an individual calculator mode 700 of a category calculator module 331 in accordance with an embodiment of the invention. In the individual calculator mode 700, the category calculator module 331 calculates data for the posts of one individual supporter or friend (e.g., 521) of the user's and shows the user the data collected and the statistics calculated in a percentile manner in the calculator box 140 of the user's home screen 100. The purpose of this mode of the category calculator module 331 is to show the data and statistics associated with one specific person. For example, if the user wished to review the data associated with a friend or supporter “John”, under the individual calculator mode 700, the calculator box 140 would show only data and statistics 710 relating to what John has posted. In contrast, under the user calculator mode 600, the calculator box 140 would show data and statistics 610 relating to what all of the user' supporters' or friends' have posted. According to one embodiment, the individual calculator mode 700 display is presented when the user clicks on or selects an individual supporter's or friend's profile in the social network application 331. That is, it is accessible when a user is viewing a supporter's or friend's profile or profile page.

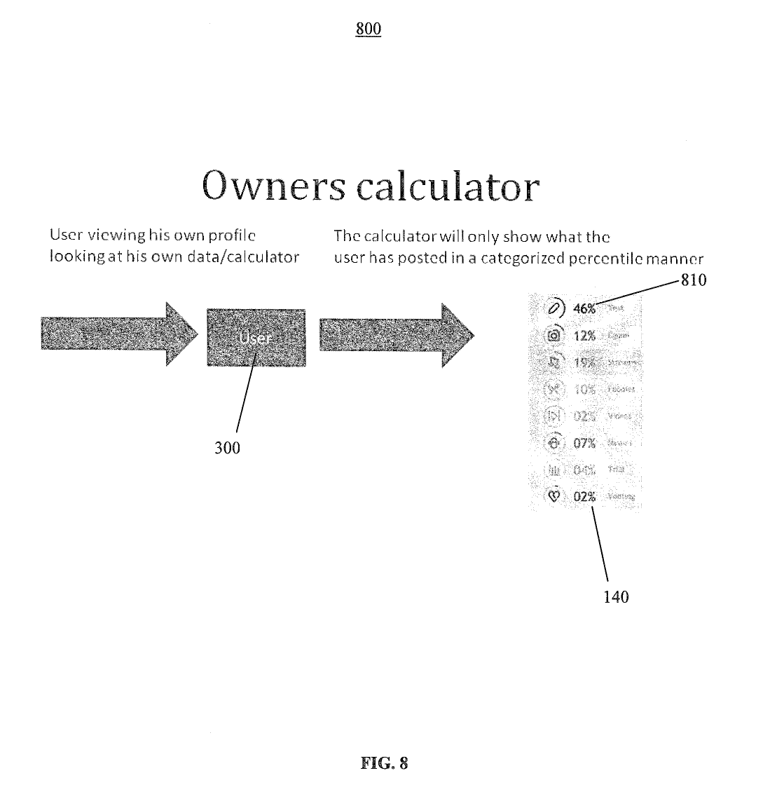

FIG. 8 is a block diagram illustrating an owner's calculator mode 800 of a category calculator module 331 in accordance with an embodiment of the invention. In the owner's calculator mode 800, the category calculator module 331 calculates data for the posts of the user (e.g., 300) and shows the user the data collected and the statistics calculated in a percentile manner in the calculator box 140 of the user's home screen 100. The purpose of this mode of the category calculator module 331 is to show the data associated with only the user. For example, if the user wished to review the data and statistics associated with him or herself, under the owner's calculator mode 800, the calculator box 140 would show only data and statistics 810 relating to what the user has posted. In contrast, under the user calculator mode 600, the calculator box 140 would show data and statistics 610 relating to what all of the user's supporters' or friends' have posted. According to one embodiment, the owner's calculator mode 800 display is presented when the user clicks on or selects the user's own profile in the social network application 331. That is, it is accessible when a user is viewing the user's own profile or profile page. The owner's calculator mode 800 allows the user to calculate and analyze data pertaining to the user's own posts in the context of the social network application's various categories 510.

According to one embodiment, the user calculator mode 600, the individual calculator mode 700, and the owner's calculator mode 800 and corresponding calculator box 140 presentations may be selected based on what the user is currently viewing. In particular, the user calculator mode 600 may be selected when the user is viewing the user's own default home page or screen. The individual calculator mode 700 may be selected when the user is viewing a supporter's or friend's profile page. And, the owner's calculator mode 800 may be selected when the user is viewing the user's own profile page. According to another embodiment, a user may select between the user calculator mode 600, the individual calculator mode 700, and the owner's calculator mode 800 at any time.

According to one embodiment, the category calculator module 331 may be used with text messaging systems, instant messaging systems, and email systems. According to one embodiment, the category calculator module 331 may be used as analytical tool for calculating purposes with respect to pulling data from users and for displaying that data to parties who have requested the data. For example, the category calculator module 331 may be used by businesses to pull data and analyze such data for internal use or for external purposes. According to one embodiment, the category calculator module 331 may be used in existing social networks (e.g., Facebook™, Twitter™, etc.) to calculate statistics based on posts or similar actions such as “likes”, etc.

The above embodiments may contribute to an improved method and system for organizing messages and reporting statistics for messages in a social network and may provide one or more advantages. First, the present invention reduces the problem of “too much information” on social networks through use of its categories 510, category calculator module 331, and percentage calculations. Second, it reduces “noise” in social networks. This provides the user with a clearer view of what is being posted and analytics with respect to these posts. Third, the present invention is easy and convenient to use. The present invention helps to keep users updated and informed with respect to what is going on in their social network by displaying popular categories 510 with a percentage statistic advising the user as to what their supporters are posting based on the categories chosen. Fourth, the present invention allows users to stay up-to-date. In particular, users may stay up-to-date with respect to their supporters' posts in real-time. Users may have information displayed to them without the users having to do anything as the category calculator box 140 may be located on the default or home page of the users' data processing systems 300 when they log in. The present invention allows a user to know what the most frequent of popular category is that is being posted to by the users' supporters or friends based on the percentage statistics that are displayed by each category in the category calculator box 140. Fifth, the present invention allows for posts to be categorized and shows a percentage statistic for each category based on each user's supporters' posts. Users are able to see what the most popular post types being uploaded are via the 3-in-1 calculator. This allows the user to be more closely connected to what is going on in the social network because the user can see all posting information in real-time. Again, the use of categories allows for the filtering of posts which makes the social network's timeline less busy or noisy. Sixth, the 3-in-1 calculator helps to consolidate information in a user friendly way that doesn't confuse the user or overload the user with too much information. Posting information and statistics are categorized and displayed in a more convenient way while also taking into account three common usage scenarios. In the first scenario (or mode 600), when the user is viewing the user's default or home page, the calculator box 140 displays data and statistics relating to all of the user's supporters' posts. In the second scenario (or mode 700), when the user is viewing an individual supporter's or friends' profile page, the calculator box 140 displays data and statistics relating to just that supporter's posts. In the third scenario (or mode 800), when the user is viewing the user's own personal profile, the calculator box 140 displays data and statistics relating to only the user's posts. Seventh, the present invention provides advantages over other social networks. In particular, the present invention addresses at least one of the root causes of the “noise” problem faced by many social networks today. For example, users who are logged off for a few hours are typically faced with too much information on their timelines when they log back in. With the present invention, time is saved as posts are categorized and the user is able to see what was the most uploaded category while the user was offline Eighth, the owner's calculator mode 800 allows the user to view data and statistics with respect to their own personal posts. For example, a user may be posting 80% in the “Text” category 511 and 20% in the “Images” category 512. Noting these statistics, the user may choose to balance the nature of their posting among these or other categories.

Aspects of the above described method may be summarized with the aid of a flowchart.

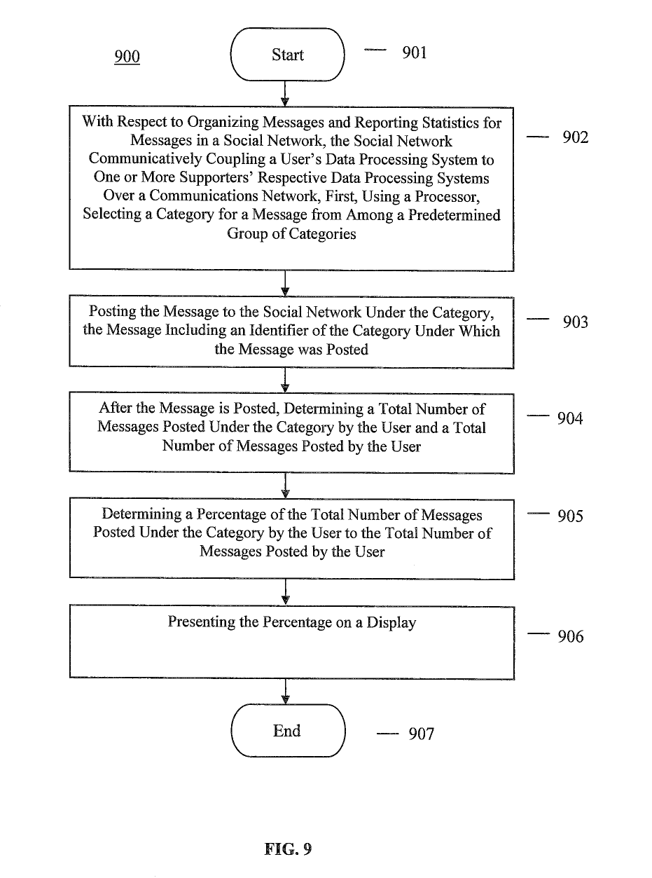

FIG. 9 is a flow chart illustrating operations 900 of modules (e.g., 331) within a data processing system (e.g., 300) for organizing messages and reporting statistics for messages in a social network, the social network communicatively coupling a user's data processing system (e.g., 300) to one or more supporters' respective data processing systems (e.g., 521, 522, 523) over a communications network 351, in accordance with an embodiment of the invention.

At step 901, the operations 900 start.

At step 902, using a processor 320, a category (e.g., 511) for a message (e.g., 520) is selected from among a predetermined group of categories (e.g., 510).

At step 903, the message 520 is posted to the social network 331 under the category 511, the message 520 including an identifier (e.g., a text string, code, symbol, etc.) 530 of the category 511 under which the message 520 was posted.

At step 904, after the message 520 is posted, a total number of messages posted under the category 511 by the user (e.g., by the user's data processing system 300) and a total number of messages posted by the user (e.g., by the user's data processing system 300) are determined.

At step 905, a percentage (e.g., 6/12 or 50%) of the total number of messages posted under the category 511 by the user (e.g., 6) to the total number of messages posted by the user (e.g., 12) is determined.

At step 906, the percentage (e.g., 50%) 810 is presented 410 on a display 340.

At step 907, the operations 900 end.

The above method may further include, for each remaining category (e.g., 512, 513, 514, 515, 516, 517, 518, 519) of the predetermined group of categories (e.g., 510): determining a respective percentage of a total number of messages posted by the user under the remaining category and the total number of messages posted by the user; and, presenting the respective percentage on the display 340. The method may further include: determining a total number of messages posted under the category 511 by the one or more supporters (e.g., by the one or more supporters' respective data processing systems 521, 522, 523) and a total number of messages posted by the one or more supporters (e.g., by the one or more supporters' respective data processing systems 521, 522, 523); determining a percentage of the total number of messages posted under the category 511 by the one or more supporters to the total number of messages posted by the one or more supporters; and, presenting 410 the percentage 610 on the display 340. The method may further include: determining a total number of messages posted under the category 511 by a selected one of the one or more supporters (i.e., by a selected one 521 of the one or more supporters' respective data processing systems 521, 522, 523); determining a percentage of the total number of messages posted under the category by the selected one of the one or more supporters to the total number of messages posted by the selected one or more supporters; and, presenting 410 the percentage 710 on the display 340. The predetermined group of categories 510 may include at least one of: a text message category 511 relating to text messages (e.g., 520); an image category 512 related to image messages; a streams category 519 relating to streams messages, wherein the user grants permission when posting a first image that it is acceptable for a supporter of the one or more supporters to post a second image against the first image, and wherein the one or more supporters vote for a preferred image of the first image and the second image; a foodies category 513 relating to food image messages; a memes category 514 relating to memes messages; a videos category 515 relating to video messages; a trials category 516 relating to trials messages, wherein the user grants permission when posting a first text message that it is acceptable for a supporter of the one or more supporters to post a second text message against the first text message, and wherein the one or more supporters vote for a preferred text message of the first text message and the second text message; a venting category 517 relating to anonymous messages; and, an audio category 518 relating to audio messages. The method may further include composing the message (e.g., 520). The method may further include presenting the message 520 in a listing of messages 120 associated with the category 511 under which the message 520 was posted on the display 340. The listing of messages 120 may be a timeline presentation 120. The method may further include: receiving a message 520 from a supporter (i.e., from a supporter's data processing system 521), the message 520 from the supporter 521 including an identifier 530 of the category (e.g., 511) under which the message 520 from the supporter 521 was posted; and, presenting the message 520 in a listing of messages 120 associated with the category 511 under which the message 520 from the supporter 521 was posted on the display 340. And, the social network may be a social network application 331 running on the user's data processing system 300 and on the one or more supporters' respective data processing systems 521, 522, 523.

According to one embodiment, each of the above steps 901-907 may be implemented by a respective software module 331. According to another embodiment, each of the above steps 901-907 may be implemented by a respective hardware module 321. According to another embodiment, each of the above steps 901-907 may be implemented by a combination of software 331 and hardware modules 321. For example, FIG. 9 may represent a block diagram illustrating the interconnection of specific hardware modules 901-907 (collectively 321) within the data processing system 300, each hardware module 901-907 adapted or configured to implement a respective step of the method of the invention. As such, the present invention advantageously improves the operation of the data processing system 300.

While this invention is primarily discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium or computer program product including program instructions recorded thereon, may direct the data processing system 300 to facilitate the practice of the method of the invention. It is understood that such apparatus, products, and articles of manufacture also come within the scope of the invention.

In particular, the sequences of instructions which when executed cause the method described herein to be performed by the data processing system 300 may be contained in a data carrier product according to one embodiment of the invention. This data carrier product may be loaded into and run by the data processing system 300. In addition, the sequences of instructions which when executed cause the method described herein to be performed by the data processing system 300 may be contained in a computer software product or computer program product (e.g., comprising a non-transitory medium) according to one embodiment of the invention. This computer software product or computer program product may be loaded into and run by the data processing system 300. Moreover, the sequences of instructions which when executed cause the method described herein to be performed by the data processing system 300 may be contained in an integrated circuit product (e.g., a hardware module or modules 321) which may include a coprocessor or memory according to one embodiment of the invention. This integrated circuit product may be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for organizing messages and reporting statistics for messages in a social network, the social network communicatively coupling a user's data processing system to one or more supporters' respective data processing systems over a communications network, the method comprising:
using a processor, selecting a category for a message from among a predetermined group of categories;
posting the message to the social network under the category, the message including an identifier of the category under which the message was posted;
after the message is posted, determining a total number of messages posted under the category by the user and a total number of messages posted by the user;
determining a percentage of the total number of messages posted under the category by the user to the total number of messages posted by the user; and, presenting the percentage on a display.

2. The method of claim 1, further comprising, for each remaining category of the predetermined group of categories: determining a respective percentage of a total number of messages posted by the user under the remaining category and the total number of messages posted by the user; and, presenting the respective percentage on the display.

3. The method of claim 1, further comprising: determining a total number of messages posted under the category by the one or more supporters and a total number of messages posted by the one or more supporters; determining a percentage of the total number of messages posted under the category by the one or more supporters to the total number of messages posted by the one or more supporters; and, presenting the percentage on the display.

4. The method of claim 1, further comprising: determining a total number of messages posted under the category by a selected one of the one or more supporters; determining a percentage of the total number of messages posted under the category by the selected one of the one or more supporters to the total number of messages posted by the selected one or more supporters; and, presenting the percentage on the display.

5. The method of claim 1, wherein the predetermined group of categories includes at least one of: a text message category relating to text messages; an image category related to image messages; a streams category relating to streams messages, wherein the user grants permission when posting a first image that it is acceptable for a supporter of the one or more supporters to post a second image against the first image, and wherein the one or more supporters vote for a preferred image of the first image and the second image; a foodies category relating to food image messages; a memes category relating to memes messages; a videos category relating to video messages; a trials category relating to trials messages, wherein the user grants permission when posting a first text message that it is acceptable for a supporter of the one or more supporters to post a second text message against the first text message, and wherein the one or more supporters vote for a preferred text message of the first text message and the second text message; a venting category relating to anonymous messages; and, an audio category relating to audio messages.

6. The method of claim 1, further comprising composing the message.

7. The method of claim 1, further comprising, presenting the message in a listing of messages associated with the category under which the message was posted on the display.

8. The method of claim 7, wherein the listing of messages is a timeline presentation.

9. The method of claim 7, further comprising: receiving a message from a supporter, the message from the supporter including an identifier of the category under which the message from the supporter was posted; and, presenting the message in a listing of messages associated with the category under which the message from the supporter was posted on the display.

10. The method of claim 1, wherein the social network is a social network application running on the user's data processing system and on the one or more supporters' respective data processing systems.

11. A system for organizing messages and reporting statistics for messages in a social network, the social network communicatively coupling the system to one or more supporters' respective systems over a communications network, comprising:
a processor coupled to memory, a display, and an interface to the communications network; and,
at least one of hardware and software modules within the memory and controlled or executed by the processor, the modules including:
a module for selecting a category for a message from among a predetermined group of categories;
a module for posting the message to the social network application under the category, the message including an identifier of the category under which the message was posted;
a module for, after the message is posted, determining a total number of messages posted under the category by the system and a total number of messages posted by the system;
a module for determining a percentage of the total number of messages posted under the category by the system to the total number of messages posted by the system; and, a module for presenting the percentage on the display.

12. The system of claim 11, further comprising a module for, for each remaining category of the predetermined group of categories: determining a respective percentage of a total number of messages posted by the system under the remaining category and the total number of messages posted by the system; and, presenting the respective percentage on the display.

13. The system of claim 11, further comprising a module for: determining a total number of messages posted under the category by the one or more supporters' systems and a total number of messages posted by the one or more supporters' systems; determining a percentage of the total number of messages posted under the category by the one or more supporters' systems to the total number of messages posted by the one or more supporters' systems; and, presenting the percentage on the display.

14. The system of claim 11, further comprising a module for: determining a total number of messages posted under the category by a selected one of the one or more supporters' systems; determining a percentage of the total number of messages posted under the category by the selected one of the one or more supporters' systems to the total number of messages posted by the selected one or more supporters' systems; and, presenting the percentage on the display.

15. The system of claim 11, wherein the predetermined group of categories includes at least one of: a text message category relating to text messages; an image category related to image messages; a streams category relating to streams messages, wherein the system grants permission when posting a first image that it is acceptable for a supporter system of the one or more supporters' systems to post a second image against the first image, and wherein the one or more supporters' systems vote for a preferred image of the first image and the second image; a foodies category relating to food image messages; a memes category relating to memes messages; a videos category relating to video messages; a trials category relating to trials messages, wherein the system grants permission when posting a first text message that it is acceptable for a supporter's system of the one or more supporters' systems to post a second text message against the first text message, and wherein the one or more supporters' systems vote for a preferred text message of the first text message and the second text message; a venting category relating to anonymous messages; and, an audio category relating to audio messages.

16. The system of claim 11, further comprising a module for composing the message.

17. The system of claim 11, further comprising, a module for presenting the message in a listing of messages associated with the category under which the message was posted on the display.

18. The system of claim 17, wherein the listing of messages is a timeline presentation.

19. The system of claim 17, further comprising a module for: receiving a message from a supporter's system, the message from the supporter's system including an identifier of the category under which the message from the supporter's system was posted; and, presenting the message in a listing of messages associated with the category under which the message from the supporter's system was posted on the display.

20. The system of claim 11, wherein the social network is a social network application running on the system and on the one or more supporters' respective systems.
